(19) United States
(12) Patent Application Publication
(10) Pub. No.: US 2019/0071073 A1
(43) Pub. Date: Mar. 7, 2019

(54) VEHICLE CONTROL APPARATUS, VEHICLE, PROCESSING METHOD OF VEHICLE CONTROL APPARATUS, AND STORAGE MEDIUM

(71) Applicant: HONDA MOTOR CO., LTD., Tokyo (JP)

(72) Inventor: Shohei Yamashita, Wako-shi (JP)

(21) Appl. No.: 16/059,280

(22) Filed: Aug. 9, 2018

(30) Foreign Application Priority Data
Sep. 1, 2017 (JP) 2017-168787

(51) Int. Cl. B60W 30/09; B60W 30/095; B60W 30/16

(52) U.S. Cl. CPC B60W 30/09; B60W 30/0956; B60W 2550/304; B60W 2550/308; B60W 2550/306; B60W 30/16

(57) ABSTRACT

A vehicle control apparatus comprising: an acquisition unit configured to acquire peripheral information of a self-vehicle; a detection unit configured to detect, based on the peripheral information, another vehicle approaching from one of a rear side and a lateral side of the self-vehicle; and a control unit configured to control an avoidance operation of the self-vehicle based on the other vehicle, wherein in a case in which the same other vehicle is detected not less than a predetermined number of times within a predetermined time, or in a case in which the same other vehicle is detected for not less than a predetermined time, the control unit controls to suppress a new avoidance operation.

### BACKGROUND OF THE INVENTION

### Field of the Invention

The present invention relates to a vehicle control apparatus, a vehicle, a processing method of the vehicle control apparatus, and a storage medium.

### Description of the Related Art

Japanese Patent Laid-Open No. 2012-243069 describes a technique of suppressing a notification unnecessary and annoying for a driver, which is made in accordance with detection of another vehicle existing on a rear lateral side of a self-vehicle. There is also known an avoidance operation of changing the lane or performing offset traveling to increase the distance from another vehicle upon detecting an approach of the other vehicle.

In Japanese Patent Laid-Open No. 2012-243069, however, how to control the operation of the self-vehicle in accordance with detection of the other vehicle existing on the rear lateral side of the self-vehicle is not taken into consideration at all. For this reason, hunting of a lane change or left/right offset may occur due to a repetitive lane change operation in a case in which a specific following vehicle approaches a plurality of times even after a lane change or a repetitive left/right offset operation in a case in which a specific vehicle traveling side by side approaches a plurality of times and influence the ride comfort of the driver. That is, an excessive avoidance operation may occur.

The present invention provides a technique for suppressing an excessive avoidance operation and implementing comfortable automated driving.

### SUMMARY OF THE INVENTION

According to one aspect of the present invention, there is provided a vehicle control apparatus comprising: an acquisition unit configured to acquire peripheral information of a self-vehicle; a detection unit configured to detect, based on the peripheral information, another vehicle approaching from one of a rear side and a lateral side of the self-vehicle; and a control unit configured to control an avoidance operation of the self-vehicle based on the other vehicle, wherein in a case in which the same other vehicle is detected not less than a predetermined number of times within a predetermined time, or in a case in which the same other vehicle is detected for not less than a predetermined time, the control unit controls to suppress a new avoidance operation.

### BRIEF DESCRIPTION OF THE DRAWINGS

FIG. 1 is a block diagram for explaining an example of the arrangement of a vehicle;

FIG. 2 is a plan view for explaining an example of arrangement positions of detection units;

FIG. 3 is a flowchart showing an example of automated driving processing according to the first embodiment;

FIG. 4 is a view showing the state of another vehicle approaching from the rear side and a lane change operation;

FIG. 5 is a view showing the state of another vehicle approaching from a lateral side and an offset operation; and

FIG. 6 is a flowchart showing an example of automated driving processing according to the second embodiment.

### DESCRIPTION OF THE EMBODIMENTS

An embodiment of the present invention will now be described with reference to the accompanying drawings. Note that the drawings are schematic views showing structures or arrangements according to the embodiment, and the dimensions of members shown in the drawings do not necessarily reflect the actuality.

### First Embodiment

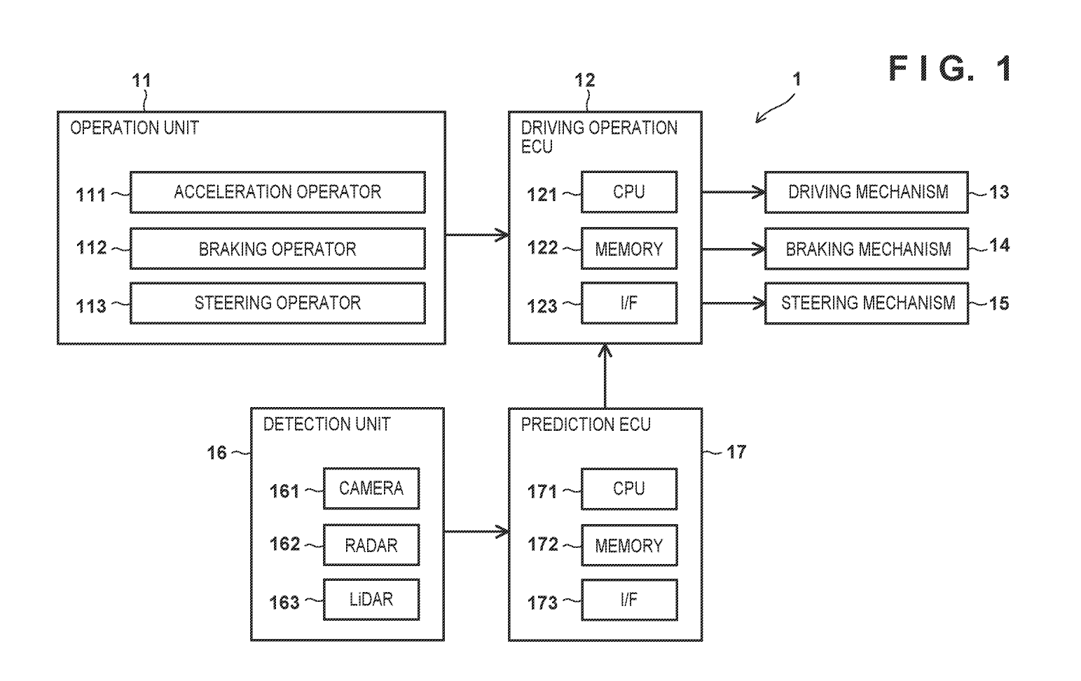

FIG. 1 is a block diagram for explaining the arrangement of a vehicle 1 according to the first embodiment. The vehicle 1 includes an operation unit 11, an driving operation ECU (Electronic Control Unit) 12, a driving mechanism 13, a braking mechanism 14, a steering mechanism 15, a detection unit 16, and a prediction ECU 17. Note that in this embodiment, the vehicle 1 is a four-wheeled vehicle. However, the number of wheels is not limited to four.

The operation unit 11 includes an acceleration operator 111, a braking operator 112, and a steering operator 113. Typically, the acceleration operator 111 is an accelerator pedal, the braking operator 112 is a brake pedal, and the steering operator 113 is a steering wheel. However, a lever type or a button type may be used for the operators 111 to 113.

The driving operation ECU 12 includes a CPU 121, a memory 122, and a communication interface 123. The CPU 121 performs predetermined processing based on an electrical signal received from the operation unit 11 via the communication interface 123. Then, the CPU 121 stores the processing result in the memory 122 or outputs it to the mechanisms 13 to 15 via the communication interface 123. With this arrangement, the driving operation ECU 12 controls the mechanisms 13 to 15.

The driving operation ECU 12 is not limited to this arrangement, and a semiconductor device such as an ASIC (Application Specific Integrated Circuit) may be used as another embodiment. That is, the function of the driving operation ECU 12 can be implemented by either hardware or software. In addition, the driving operation ECU 12 is shown here as a single element for the sake of descriptive simplicity but may be divided into a plurality of elements. The driving operation ECU 12 may be divided into, for example, three ECUs for acceleration, braking, and steering.

The driving mechanism 13 includes, for example, an internal combustion engine and a transmission. The braking mechanism 14 is, for example, a disc brake provided on each wheel. The steering mechanism 15 includes, for example, a power steering. The driving operation ECU 12 controls the driving mechanism 13 based on the operation amount of the acceleration operator 111 by a driver. In addition, the driving operation ECU 12 controls the braking mechanism 14 based on the operation amount of the braking operator 112 by the driver. Also, the driving operation ECU 12 controls the steering mechanism 15 based on the operation amount of the steering operator 113 by the driver.

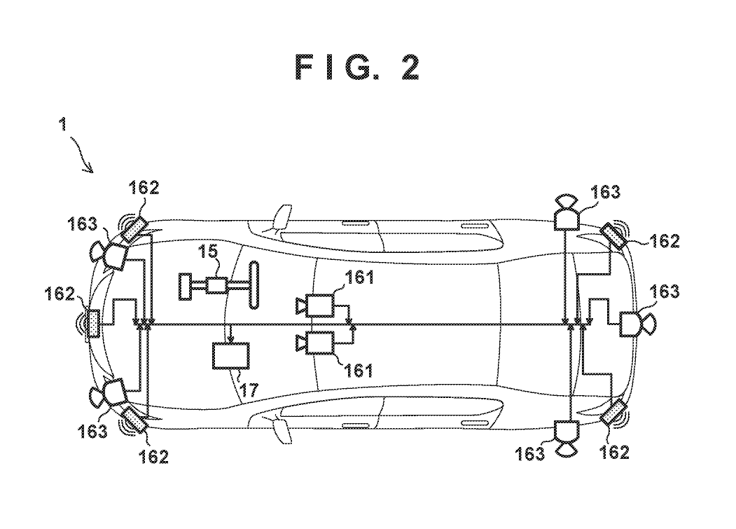

The detection unit 16 includes a camera 161, a radar 162, and a LiDAR (Light Detection and Ranging) 163. The camera 161 is, for example, an image capturing device using a CCD/CMOS image sensor. The radar 162 is, for example, a distance measuring device such as a millimeter-wave radar. The LiDAR 163 is, for example, a distance measuring device such as a laser radar. These devices are arranged at positions where peripheral information of the vehicle 1 can be detected, for example, on the front side, rear side, upper side, and lateral sides of the vehicle body, as shown in FIG. 2.

Here, in this specification, expressions such as front, rear, upper, and lateral (left/right) are sometimes used. These are used as expressions indicating relative directions based on the vehicle body. For example, “front” indicates the front in the longitudinal direction of the vehicle body, and “upper” indicates the height direction of the vehicle body.

The vehicle 1 can perform automated driving based on the detection result (the peripheral information of the vehicle 1) by the detection unit 16. In this specification, automated driving means partially or wholly performing the driving operation (acceleration, braking, and steering) not on the driver side but on the side of the driving operation ECU 12. That is, the concept of automated driving includes a form (so-called full automated driving) in which the driving operation is wholly performed on the side of the driving operation ECU 12 and a form (so-called driving support) in which part of the driving operation is performed on the side of the driving operation ECU 12. Examples of driving support are a vehicle speed control (automatic cruise control) function, a following distance control (adaptive cruise control) function, a lane departure prevention support (lane keep assist) function, a collision avoidance support function, and the like.

The prediction ECU 17 predicts the behavior of each object (for example, another vehicle) on a road. The prediction ECU 17 may be referred to as a prediction apparatus, a behavior prediction apparatus, or the like, or may be referred to as a processing apparatus (processor), an information processing apparatus, or the like (or may be called a device, module, unit, or the like in place of an apparatus). When performing automated driving, the driving operation ECU 12 controls some or all of the operators 111 to 113 based on the prediction result of the prediction ECU 17. The prediction ECU 17 and the driving operation ECU 12 may be referred to as a vehicle control apparatus altogether.

The prediction ECU 17 has the same arrangement as the driving operation ECU 12, and includes a CPU 171, a memory 172, and a communication interface 173. The CPU 171 acquires peripheral information of the vehicle 1 from the detection unit 16 via the communication interface 173. The CPU 171 predicts the behavior of each object on the road based on the peripheral information, and stores the prediction result in the memory 172 or outputs it to the driving operation ECU 12 via the communication interface 173.

<Automated Driving Processing>

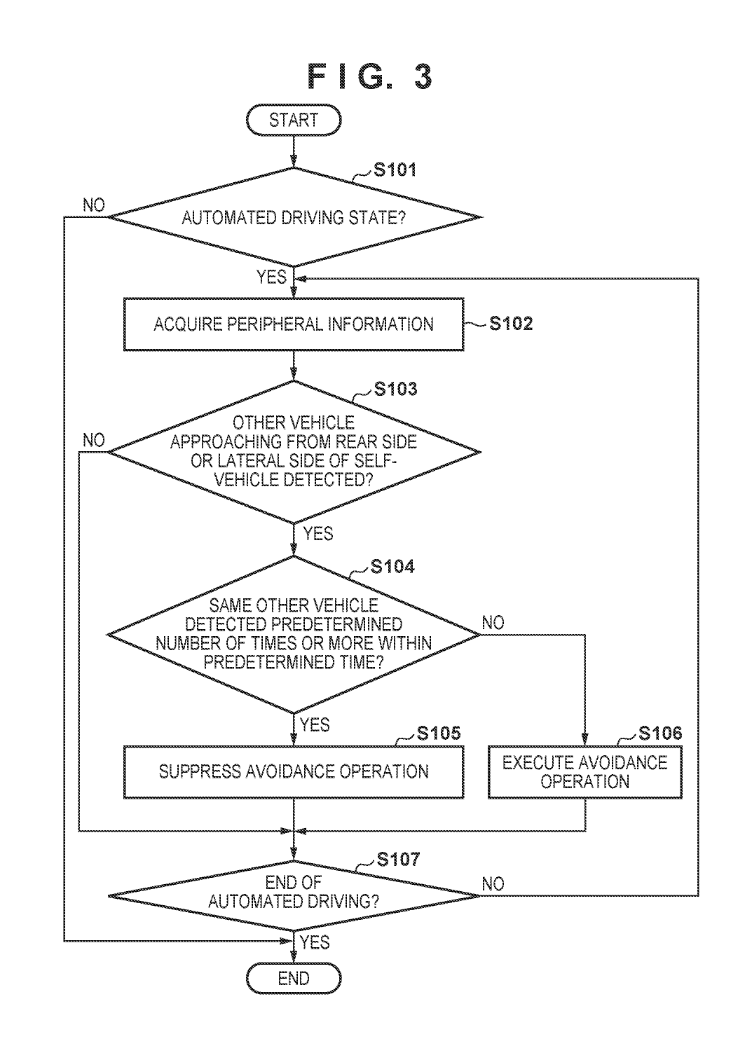

FIG. 3 is a flowchart showing the procedure of processing for performing automated driving according to this embodiment. The contents of the flowchart are mainly performed by the CPU 171 of the prediction ECU 17 and the CPU 121 of the driving operation ECU 12. When the self-vehicle 1 starts automated driving, the prediction ECU 17 recognizes each object on the periphery of the self-vehicle 1 based on the peripheral information of the self-vehicle 1, predicts the behavior of each object, and outputs the result to the driving operation ECU 12. The driving operation ECU 12 controls the operation of the self-vehicle 1 based on the prediction result acquired from the prediction ECU 17.

In step S101, the prediction ECU 17 determines whether the self-vehicle 1 is in the automated driving state or not. This step is performed when, for example, the prediction ECU 17 receives a signal representing whether the self-vehicle 1 is in the automated driving state or not from the driving operation ECU 12. If the self-vehicle 1 is in the automated driving state, the process advances to step S102. If the self-vehicle 1 is not in the automated driving state, the flowchart ends.

In step S102, the prediction ECU 17 acquires the peripheral information of the self-vehicle 1. This step is performed when the prediction ECU 17 receives the peripheral information of the self-vehicle 1 detected by the detection unit 16.

In step S103, the prediction ECU 17 detects each object existing on the periphery of the self-vehicle 1 from the peripheral information obtained in step S102. This step is performed by performing predetermined data processing (for example, data processing of extracting a contour) for data representing the peripheral information. The prediction ECU 17 then determines whether another vehicle approaching from the rear side or a lateral side of the self-vehicle 1 is detected as an object.

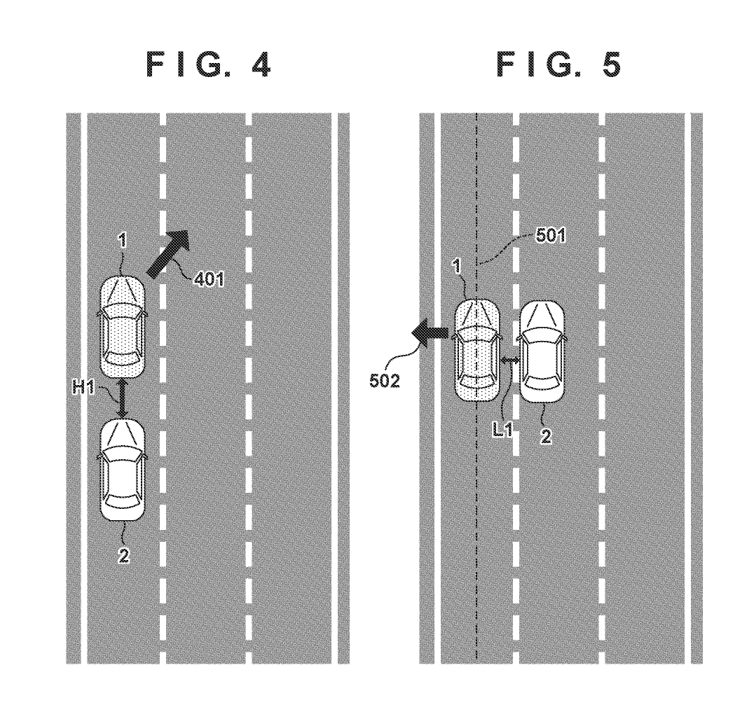

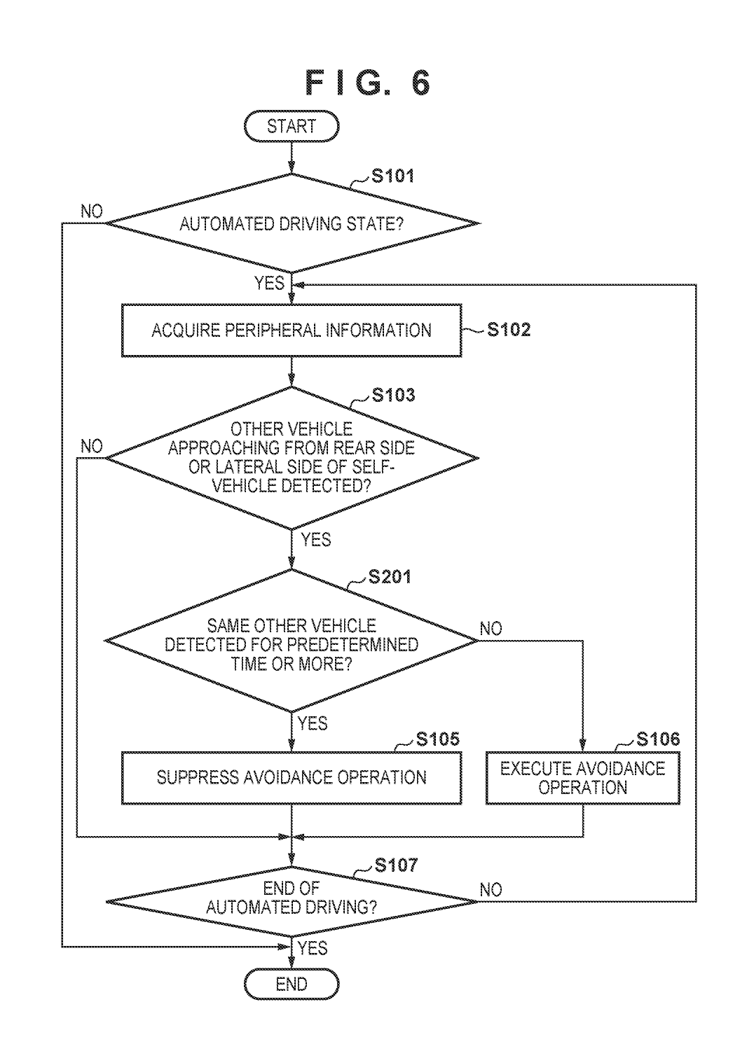

For example, as shown in FIG. 4, a distance H1 between the self-vehicle 1 and another vehicle 2 traveling on the rear side of the self-vehicle 1 is calculated. If the distance H1 is equal to or less than a threshold, it is determined that the other vehicle approaching from the rear side is detected. Note that it may be determined that the other vehicle approaching from the rear side is detected when the time in which the distance H1 is equal to or less than the threshold exceeds a set time. In addition, as shown in FIG. 5, a distance L1 between the self-vehicle 1 and another vehicle 2 traveling on a lateral side of the self-vehicle 1 is calculated. If the distance L1 is equal to or less than a threshold, it is determined that the other vehicle approaching from the lateral side is detected. Similarly, it may be determined that the other vehicle approaching from the lateral side is detected when the time in which the distance L1 is equal to or less than the threshold exceeds a set time. This can prevent an unnecessary avoidance operation from being executed for the other vehicle that only happens to approach.

If it is determined that the other vehicle approaching from the lateral side or the rear side of the self-vehicle 1 is detected, the process advances to step S104. If it is determined that the other vehicle approaching from the lateral side or the rear side of the self-vehicle 1 is not detected, the process advances to step S107.

In step S104, the prediction ECU 17 determines whether the same other vehicle is detected a predetermined number of times or more within a predetermined time. If it is determined that the same other vehicle is detected a predetermined number of times or more within a predetermined time, the process advances to step S105. On the other hand, if it is determined that the same other vehicle is not detected a predetermined number of times or more within a predetermined time, the process advances to step S106.

Whether the same other vehicle is detected or not is determined by assigning an identifier to the other vehicle detected in the past and performing the determination based on the identifier. The predetermined time and the predetermined number of times may be set in advance or may be input directly by the driver. Alternatively, several combinations may be prepared, and the driver may be allowed to select one of them. Note that if the same other vehicle is detected many times in a short period, it is predicted that, for example, the self-vehicle 1 is being tailgated by the other vehicle 2 traveling on the rear side of the self-vehicle 1, or the other vehicle 2 traveling on the lateral side of the self-vehicle 1 is approaching to observe the state of automated driving. The result of the determination in step S104 is output to the driving operation ECU 12.

In step S105, the driving operation ECU 12 controls to suppress a new avoidance operation based on the output result from the prediction ECU 17. The avoidance operation here is a lane change operation (for example, an arrow 401 shown in FIG. 4) for the other vehicle 2 approaching from the rear side of the self-vehicle 1 or an offset operation of traveling in the traveling lane of the self-vehicle 1 at a distance from the other vehicle 2 approaching from the lateral side of the self-vehicle 1. The offset operation is an operation of traveling at a distance in a direction (arrow 502) to separate from the other vehicle 2 with respect to the lane center position (for example, a dotted line 501 shown in FIG. 5) of the traveling lane of the self-vehicle 1.

Suppression of the avoidance operation is control to inhibit the offset operation and maintain the current offset distance (maintain the current traveling position in the lane) even if, for example, the other vehicle 2 approaching from the lateral side of the self-vehicle 1 is detected. Alternatively, the suppression may be control to inhibit the offset operation and return the self-vehicle 1 to the traveling position before the start of the offset operation. The traveling position before the start of the offset operation may be, for example, the lane center position (for example, the dotted line 501).

In addition, suppression of the avoidance operation is control to inhibit the lane change operation even if, for example, the other vehicle 2 approaching from the rear side of the self-vehicle 1 is detected.

This can suppress an excessive avoidance operation and implement comfortable automated driving.

In step S106, the driving operation ECU 12 controls to execute the avoidance operation based on the output result from the prediction ECU 17.

In step S107, the prediction ECU 17 determines whether to end the automated driving state of the self-vehicle 1. This step is performed when, for example, the prediction ECU 17 receives a signal representing an end of the automated driving state from the driving operation ECU 12. If the automated driving state is not to be ended, the process returns to step S102. If the automated driving state is to be ended, the flowchart ends.

The series of steps S101 to S107 is repetitively performed at a period of, for example, about 10 [msec] or a shorter period. That is, acquisition of the peripheral information of the self-vehicle 1, detection of each object on the periphery of the self-vehicle 1, output of the prediction result of the behaviors of the objects to the driving operation ECU 12, and behavior control of the self-vehicle 1 by the driving operation ECU 12 are periodically performed.

Note that the steps of this flowchart may be changed without departing from the scope of the present invention. For example, the order of the steps may be changed, some steps may be omitted, or another step may be added.

As described above, in this embodiment, the other vehicle approaching from the rear side or the lateral side of the self-vehicle is detected based on the peripheral information of the self-vehicle. If the same other vehicle is detected a predetermined number of times or more within a predetermined time, control is performed to suppress a new avoidance operation.

According to this embodiment, it is possible to suppress excessive repeat of the avoidance operation and implement comfortable automated driving.

### Second Embodiment

In the first embodiment, an example in which another vehicle approaching from the rear side or a lateral side of the self-vehicle is detected based on the peripheral information of the self-vehicle, and when the same other vehicle is detected a predetermined number of times or more within a predetermined time, control is performed to suppress a new avoidance operation has been described. On the other hand, in the second embodiment, an example in which when the same other vehicle is detected for a predetermined time or more, control is performed to suppress a new avoidance operation will be described.

The apparatus arrangement is the same as in the first embodiment. The difference from the first embodiment will mainly be described below.

<Automated Driving Processing>

FIG. 6 is a flowchart showing the procedure of processing for performing automated driving according to this embodiment. The processes of steps S101 to S103 and S105 to S107 in the flowchart shown in FIG. 6 are the same as the corresponding processes in FIG. 3. In this embodiment, the process of step S201 is performed in place of the process of step S104 in FIG. 3.

In step S201, a prediction ECU 17 determines whether the same other vehicle approaching from the rear side or a lateral side of a self-vehicle 1 is detected for a predetermined time or more. If it is determined that the same other vehicle is detected for a predetermined time or more, the process advances to step S105. On the other hand, if it is determined that the same other vehicle is not detected for a predetermined time or more, the process advances to step S106. The result of the determination in step S201 is output to a driving operation ECU 12.

Whether the same other vehicle is detected or not is determined by assigning an identifier to the other vehicle detected in the past and performing the determination based on the identifier, as in the first embodiment. The predetermined time may be set in advance or may be input directly by the driver. Alternatively, several choices may be prepared, and the driver may be allowed to select one of them.

Note that if the same other approaching vehicle is detected for a predetermined time or more, it is predicted that, for example, the self-vehicle 1 is being tailgated by another vehicle 2 traveling on the rear side of the self-vehicle 1, and tracked continuously even after an avoidance operation (lane change operation) is executed. Alternatively, if the same other approaching vehicle is detected for a predetermined time or more, as another example, it is predicted that the other vehicle 2 traveling on the lateral side of the self-vehicle 1 is approaching, and even after an avoidance operation (offset operation) is executed, the other vehicle 2 is approaching again to continuously observe the state of automated driving.

Note that the time in which the same other approaching vehicle is detected in step S201 may be the cumulative time of times in which the distance between the self-vehicle 1 and the other vehicle 2 is equal to or less than a threshold. This is because when the avoidance operation is performed, there can be a time in which the distance between the self-vehicle 1 and the other vehicle 2 exceeds the threshold until the other vehicle 2 approaches again.

Then, as described in the first embodiment, in step S103 of FIG. 6, if it is determined that the other vehicle approaching from the rear side is detected in a case in which the time in which a distance H1 between the self-vehicle 1 and the other vehicle 2 traveling on the rear side of the self-vehicle 1 is equal to or less than the threshold exceeds a set time, the predetermined time is set to a value larger than the set time.

Similarly, if it is determined that the other vehicle approaching from a lateral side is detected in a case in which the time in which a distance L1 between the self-vehicle 1 and the other vehicle 2 traveling on a lateral side of the self-vehicle 1 is equal to or less than a threshold exceeds a set time, the predetermined time is set to a value larger than the set time.

As described above, in this embodiment, the other vehicle approaching from the rear side or the lateral side of the self-vehicle is detected based on the peripheral information of the self-vehicle. If the same other vehicle is detected for a predetermined time or more, control is performed to suppress a new avoidance operation.

According to this embodiment, it is possible to suppress excessive repeat of the avoidance operation and implement comfortable automated driving.

### Other Embodiments

Several preferred embodiments have been described above. However, the present invention is not limited to these examples and may partially be modified without departing from the scope of the invention. For example, other elements may be combined with the contents of the embodiments in accordance with the object, application purpose, and the like, and the contents of a certain embodiment may be combined with some of the contents of another embodiment. In addition, individual terms described in this specification are merely used for the purpose of explaining the present invention, and the present invention is not limited to the strict meanings of the terms and can also incorporate their equivalents.

In addition, a program that implements one or more functions described in the embodiments is supplied to a system or apparatus via a network or a storage medium, and one or more processors in the computer of the system or apparatus can read out and execute the program. The present invention can be implemented by this form as well.

### Summary of Embodiment

A vehicle control apparatus (for example, 12, 17) according to the first aspect comprises:

an acquisition unit (for example, 171, S102) configured to acquire peripheral information of a self-vehicle (for example, 1);

a detection unit (for example, 171, S103) configured to detect, based on the peripheral information, another vehicle (for example, 2) approaching from one of a rear side and a lateral side of the self-vehicle; and

a control unit (for example, 121) configured to control an avoidance operation (for example, a lane change operation, an offset operation) of the self-vehicle based on the other vehicle,

wherein in a case in which the same other vehicle is detected not less than a predetermined number of times within a predetermined time (for example, 121, S104), or in a case in which the same other vehicle is detected for not less than a predetermined time (for example, 121, S201), the control unit controls to suppress a new avoidance operation.

According to the first aspect, it is possible to suppress excessive repeat of the avoidance operation and implement comfortable automated driving.

In the second aspect, the avoidance operation is one of a lane change operation (for example, 401) for the other vehicle (for example, 2) approaching from the rear side of the self-vehicle (for example, 1) and an offset operation (for example, 502) of traveling in a traveling lane of the self-vehicle at a distance from the other vehicle approaching from the lateral side of the self-vehicle.

According to the second aspect, it is possible to suppress excessive repeat of the lane change operation or the offset operation and implement comfortable automated driving.

In the third aspect, the avoidance operation is an operation of traveling at the distance in a direction (for example, 502) to separate from the other vehicle with respect to a lane center position (for example, 501) of the traveling lane of the self-vehicle.

According to the third aspect, offset is done with respect to the other vehicle based on the lane center position, thereby improving the sense of security of the driver.

In the fourth aspect, suppression of the avoidance operation includes control to inhibit an offset operation of traveling in a traveling lane of the self-vehicle at a distance from the other vehicle approaching from the lateral side of the self-vehicle and maintain a current offset distance.

According to the fourth aspect, since an excessive offset operation is not performed for approaching from the lateral side, and stable traveling can be implemented, the sense of security of the driver can be improved.

In the fifth aspect, suppression of the avoidance operation includes control to inhibit an offset operation of traveling in a traveling lane of the self-vehicle at a distance from the other vehicle approaching from the lateral side of the self-vehicle and return the self-vehicle to a traveling position before a start of the offset operation.

According to the fifth aspect, since an excessive offset operation is not performed for approaching from the lateral side, and the self-vehicle is returned to the traveling position before the start of the offset operation to implement stable traveling without any influence of the behavior of the other vehicle, the sense of security of the driver can be improved.

In the sixth aspect, the traveling position before the start of the offset operation is a lane center position (for example, 501).

According to the sixth aspect, since an excessive offset operation is not performed for approaching from the lateral side, and the self-vehicle is returned to the lane center position to implement stable traveling without any influence of the behavior of the other vehicle, the sense of security of the driver can be improved.

In the seventh aspect, suppression of the avoidance operation includes control to inhibit a lane change operation (for example, 401) for the other vehicle approaching from the rear side of the self-vehicle.

According to the seventh aspect, since an excessive lane change operation is not performed for approaching from the rear side, stable traveling without any influence of the behavior of the other vehicle can be improved, and the sense of security of the driver can be improved.

In the eighth aspect, the control unit assigns an identifier to the other vehicle detected by the detection unit, thereby determining based on the identifier whether the same other vehicle is detected or not.

According to the eighth aspect, management by the identifier is performed, thereby appropriately performing determination even if a similar vehicle is continuously traveling.

A vehicle (for example, 1) according to the ninth aspect comprises a vehicle control apparatus (for example, 12, 17) according to any one of the first to eighth aspects.

According to the ninth aspect, it is possible to suppress excessive repeat of the avoidance operation and implement comfortable automated driving by the vehicle.

A processing method of a vehicle control apparatus (for example, 12, 17) according to the 10th aspect comprises:

acquiring peripheral information of a self-vehicle (for example, 1) (for example, 171, S102);

detecting, based on the peripheral information, another vehicle (for example, 2) approaching from one of a rear side and a lateral side of the self-vehicle (for example, 171, S103); and

controlling an avoidance operation (for example, a lane change operation, an offset operation) of the self-vehicle based on the other vehicle (for example, 121),

wherein in the controlling, in a case in which the same other vehicle is detected not less than a predetermined number of times within a predetermined time (for example, 121, S104), or in a case in which the same other vehicle is detected for not less than a predetermined time (for example, 121, S201), control is performed to suppress a new avoidance operation.

According to the 10th aspect, it is possible to suppress excessive repeat of the avoidance operation and implement comfortable automated driving by the vehicle, as in the first aspect.

According to the 11th aspect, there is provided a storage medium storing a program configured to cause a computer to execute steps of a processing method of a vehicle control apparatus according to the 10th aspect.

According to the 11th aspect, it is possible to implement the processing method of the vehicle control apparatus according to the 10th aspect by the computer.

According to the present invention, it is possible to suppress an excessive avoidance operation and implement comfortable automated driving.

This application claims the benefit of Japanese Patent Application No. 2017-168787, filed Sep. 1, 2017, which is hereby incorporated by reference herein in its entirety.

What is claimed is:

1. A vehicle control apparatus comprising:
an acquisition unit configured to acquire peripheral information of a self-vehicle;
a detection unit configured to detect, based on the peripheral information, another vehicle approaching from one of a rear side and a lateral side of the self-vehicle; and
a control unit configured to control an avoidance operation of the self-vehicle based on the other vehicle,
wherein in a case in which the same other vehicle is detected not less than a predetermined number of times within a predetermined time, or in a case in which the same other vehicle is detected for not less than a predetermined time, the control unit controls to suppress a new avoidance operation.

2. The apparatus according to claim 1, wherein the avoidance operation is one of a lane change operation for the other vehicle approaching from the rear side of the self-vehicle and an offset operation of traveling in a traveling lane of the self-vehicle at a distance from the other vehicle approaching from the lateral side of the self-vehicle.

3. The apparatus according to claim 2, wherein the offset operation is an operation of traveling at the distance in a direction to separate from the other vehicle with respect to a lane center position of the traveling lane of the self-vehicle.

4. The apparatus according to claim 1, wherein suppression of the avoidance operation includes control to inhibit an offset operation of traveling in a traveling lane of the self-vehicle at a distance from the other vehicle approaching from the lateral side of the self-vehicle and maintain a current offset distance.

5. The apparatus according to claim 1, wherein suppression of the avoidance operation includes control to inhibit an offset operation of traveling in a traveling lane of the self-vehicle at a distance from the other vehicle approaching from the lateral side of the self-vehicle and return the self-vehicle to a traveling position before a start of the offset operation.

6. The apparatus according to claim 5, wherein the traveling position before the start of the offset operation is a lane center position.

7. The apparatus according to claim 1, wherein suppression of the avoidance operation includes control to inhibit a lane change operation for the other vehicle approaching from the rear side of the self-vehicle.

8. The apparatus according to claim 1, wherein the control unit assigns an identifier to the other vehicle detected by the detection unit, thereby determining based on the identifier whether the same other vehicle is detected or not.

9. A vehicle comprising a vehicle control apparatus of claim 1.

10. A processing method of a vehicle control apparatus, comprising:
acquiring peripheral information of a self-vehicle;
detecting, based on the peripheral information, another vehicle approaching from one of a rear side and a lateral side of the self-vehicle; and
controlling an avoidance operation of the self-vehicle based on the other vehicle,
wherein in the controlling, in a case in which the same other vehicle is detected not less than a predetermined number of times within a predetermined time, or in a case in which the same other vehicle is detected for not less than a predetermined time, control is performed to suppress a new avoidance operation.

11. A storage medium storing a program configured to cause a computer to execute steps of a processing method of a vehicle control apparatus of claim 10.
